(19) United States
(12) Patent Application Publication
(10) Pub. No.: US 2005/0231756 A1
(43) Pub. Date: Oct. 20, 2005

(54) Image forming apparatus

(76) Inventor: Toshiyuki Maeshima, Tokyo (JP)

Correspondence Address: CANTOR COLBURN, LLP, 55 GRIFFIN ROAD SOUTH, BLOOMFIELD, CT, 06002, US

(21) Appl. No.: 10/971,328

(22) Filed: Oct. 22, 2004

(30) Foreign Application Priority Data
Apr. 19, 2004 (JP) JP2004-122411

(51) Int. Cl. G06F 3/12; G06F 15/00; G06F 17/00; G06F 7/00

(52) U.S. Cl. 358/1.15; 715/523; 708/204; 358/1.16; 709/246

(57) ABSTRACT

An image forming apparatus capable of updating a program of data thereof, includes: a storage section for storing the data to be processed by the program; an investigation section for checking whether or not data of old format incompatible with a current program is present in the storage section; a conversion section for converting the data of old format in the storage section, into a format conforming to the current program, when the investigation section shows that the data of old format is present; and an image forming section for forming an image using the converted data.

### BACKGROUND OF THE INVENTION

The present invention relates to an image forming apparatus where a program is updated, particularly to the art of solving the problem when a program cannot be handled after the data of old format remaining in a nonvolatile memory apparatus has been updated.

Many of the digital multifunctional machines having a document copying function are equipped with a nonvolatile memory device such as a hard disk apparatus, wherein a great number of documents (image data, etc.) are stored.

The apparatus operating program may have its version upgraded on the market after shipment from the factory, in order to add or improve the function. Various arts have been proposed to update the program in the field, without the need of ROM replacement for the purpose of reducing the number of working hours (Patent Document 1, for example, represents Official Gazette of Japanese Patent Tokkaihei 11-184760).

If the program has been updated, the format of the data used by the updated program or method of accessing the data may be different from those of the data used in the original program. In such a case, rewriting of the program will disable access to the data of old format stored in the hard disk apparatus. This will require the storage device to be initialized and the data of old format to be deleted, before the rewritten program can be run on the apparatus, according to the prior art.

For example, if there remains the data of old format in a hard disk apparatus when the apparatus has been turned on after rewriting of the program, a message “Format the disk” will appear, and formatting must be performed according to this instruction, otherwise the operation does not proceed.

A serious problem arises when use of the crucial data is disabled by updating of the program.

To avoid such a problem, the data of old format is read out prior to updating of the program and the data format is updated on an external apparatus. This is put back on the storage section subsequent to updating of the program. This method, however, causes the workload to be increased as a result of updating the program.

### SUMMARY OF THE INVENTION

The present invention is intended to solve the aforementioned problems. It is accordingly an object of this invention to provide an image forming apparatus wherein use of the apparatus can be started, without having to delete the data of old format, after updating the program, and the data of old format can be used after updating the program.

The above-mentioned object can be achieved by any one of the following Structures (1) through (20).

(1) An image forming apparatus capable of updating a program of data thereof, comprising: (a) a storage section for storing the data to be processed by the program; (b) an investigation section for checking whether or not data of old format incompatible with a current program is present in the storage section; (c) a conversion section for converting the data of old format in the storage section, into a format conforming to the current program, when the investigation section shows that the data of old format is present; and (d) an image forming section for forming an image using the converted data.

According to Structure (1), if the data of old format incompatible with the current program remains in the storage section 50, the data of old format is automatically converted into the format conforming to the current program. The data to be converted is that which is to be processed by the program and can be stored in the storage section 50. It includes image data and document file. The conversion includes format conversion for header information and additional information.

Whether the data of old format is present or not can be determined by the header information of the stored data. The program for performing the functions of the investigation means 22 and conversion means 24 should be included in part of the program. Investigation by the investigation means 22 can be performed at any time. It is preferred that this investigation be carried out at the time of startup and initialization subsequent to program updating, for example.

(2) The image forming apparatus described in Structure (1), further comprising a notification control section for notifying a check result of the investigation section when the investigation section shows that the data of old format is present.

According to the Structure (2), if the data of old format incompatible with the current program remains in the storage section 50, the user is notified of this fact. Since conversion may take a long time, the user can start conversion immediately upon receipt of the notification, or can start it later when convenient.

Any method may be used for this notification. For example, an alarm message or alarm sound may be used. If the alarm message is used for display, normal operation may be resumed after the lapse of a predetermined time interval or user's operation for confirmation may be prompted. It is also preferred to notify the expected time required for conversion or the number of files required for conversion.

(3) The image forming apparatus described in Structure (2), further comprising a conversion instruction receiving section for receiving an instruction for converting the data, wherein the conversion section converts the data of old format to the format conforming to the current program, based on the conversion instruction received by the conversion instruction section.

According to Structure (3), the data of old format is converted into the format conforming to the current program, based on the conversion instruction received from the user. For example, if a conversion instruction is received on the operation screen of the administrator mode, a general user is prevented from converting the data without permission of the administrator.

(4) The image forming apparatus described in the Structure (3), wherein the conversion instruction receiving section is not displayed when the investigation section has indicated that there is no data of old format.

According to the Structure (4), when there is no data of old format in the storage section 50, the screen for inputting the conversion instruction and the operation button are not displayed, without any conversion instruction being accepted. The term “not displayed” in the sense in which it is used here refers to the state of not being displayed at all, or the disabled state (where the operation is disabled although dimly visible).

(5) The image forming apparatus described in the Structure (2), wherein when the investigation section shows that the data of old format is present, a status of the apparatus is shifted to one where execution of a job using the data of old format existed in the storage section, is restricted but execution of other jobs is permitted.

According to the Structure (5), even if the data of old format is present in the storage section 50, the job that does not use that data can be executed. The job provides as a unit when a user requests the work to be done by an image forming apparatus such as a digital multifunctional machines. It includes a copy job of copying a document, a printing job of printing according to the print data, a storage job of storing the image data obtained by reading the document, into an archive as a document, and a job of printing out or transferring the document stored in the archive.

If the data of old format is present in the storage section 50, a simple copying operation or the like is enabled, although restrictions are imposed on the job of printing or sending the document stored in the archive for personal use, for example. Thus, even when presence of the data of old format has been notified, a user desiring to execute the job that does not use the data of old format is allowed to execute the intended job immediately in such a way that conversion will be processed later.

Restrictions on the execution of the job of using the data of old format can be given by ensuring that the operation screen for designating the job does not appear. In addition to that, it is also possible to arrange such a configuration that, when the start button is operated, a check is made to determine whether or not the designated job uses the data of old format. If the data of old format is used, inputting of the job is disabled or rejected.

(6) The image forming apparatus described in Structure (2), further comprising: a job input receiving section for receiving a job inputted by a user; a judgment section for judging whether or not the job utilizes data of old format incompatible with the current program when the job has been inputted by the user; and a job restriction section for prohibiting the job to be inputted when the judgment section indicates that the data of old format is used.

According to the Structure (6), if the data of old format is used in the job inputted by the user, inputting of that job is disabled. It may be disabled by checking if such data as the designated document or image data contains an old format, or by checking the type of the job as a criterion for this checking. To put it another way, it is also possible to arrange such a configuration that inputting of any job that uses the document stored in the storage section 50 or the image data is uniformly disabled, independently of whether the data format is old or new. If the inputting of the job has been disabled, the user should be notified of the reason.

(7) The image forming apparatus described in Structure (2), further comprising: a job input receiving section for receiving a job inputted by a user;
a judgment section for judging whether or not the job utilizes data of old format incompatible with the current program when the job has been inputted by the user; and
an immediate conversion section for converting the data of old format used in the job, into a format conforming to the current program, when the judgment section indicates that the data of old format is used, wherein the image forming apparatus executes the job using the data converted by the immediate conversion section.

According to the Structure (7), when the job inputted by the user uses the data of old format, only the data of old format included therein is converted into the format conforming to the current program, and the job is executed thereafter. If all the data of old format is converted into the format conforming to the current program, a long processing is required. Since only the data used in the current job is converted, conversion time is reduced, and the next job can be started immediately.

(8) The image forming apparatus described in Structure (7), wherein the data of old format is left and the data obtained by the immediate conversion section is deleted after the execution of the job using the data converted is completed.

According to the Structure (8), the data converted for job execution is deleted after execution of the job. This arrangement prevents the data converted into the format conforming to the current program, from remaining in the storage section 50 without permission of the administrator.

(9) The image forming apparatus described in the Structures (1), wherein when a power source has been disconnected during a conversion of the data of old format into the format conforming to the current program, the conversion is restarted from the beginning after the power source is recovered, and when the power source has been disconnected during a predetermined post-processing to be performed after the conversion is completed, the predetermined post-processing is restarted from the beginning after the power source is recovered.

According to the Structure (9), conversion is composed of conversion proper and post-processing. If a power source is disconnected during conversion proper, conversion is restarted from the beginning after the power source has been recovered. If the power source has been disconnected during execution of post-processing, operation is restarted from the post-processing after the power source has been recovered. Post-processing includes deletion of the data of old format and configuration of the data management information after conversion. When conversion is restarted from the beginning, conversion should be started after deleting the data of need format having been converted halfway, before the power source is disconnected.

(10) The image forming apparatus described in the Structures (1), further comprising: a job input receiving section for receiving a job inputted; a judgment section for judging whether or not the job utilizes data of old format incompatible with the current program when the job has been inputted; and a job restriction section for prohibiting the job to be inputted when the judgment section indicates that the data of old format is used.

According to the Structure (10), if the data of old format is used in the job inputted by the user, inputting of that job is disabled.

(11) The image forming apparatus described in the Structures (1), further comprising: a job input receiving section for receiving a job inputted; a judgment section for judging whether or not the job utilizes data of old format incompatible with the current program when the job has been inputted; and an immediate conversion section for converting the data of old format used in the job, into a format conforming to the current program, when the judgment section indicates that the data of old format is used, wherein the image forming apparatus executes the job using the data converted by the immediate conversion section.

According to the Structure (11), when the job inputted by the user uses the data of old format, only the data of old format included therein is converted into the format conforming to the current program, and the job is executed thereafter.

(12) The image forming apparatus described in the Structure (11), wherein the data of old format is left unchanged and the data converted by the immediate conversion section is deleted after the execution of the job using the data is completed.

According to the Structure (12), the data converted for execution of the job is deleted subsequent to execution of the job.

(13) The image forming apparatus described in any one of the Structures (1), wherein the data to be processed by the program is image data.

Image data includes the data obtained by reading a document and the data obtained by converting the printed data into a raster image.

(14) The image forming apparatus described in any one of the Structures (1), wherein the investigation section operates when the program is rewritten.

According to the Structure (14), immediately after the program has been rewritten, investigation is made to see whether or not data of old format incompatible with the current program is present in the storage apparatus.

(15) The image forming apparatus described in any one of the Structures (1), wherein the investigation section operates at the time of start-up and initialization of the image forming apparatus.

According to the Structure (15), investigation is made to see whether or not data of old format is present in the storage section, at the time of resetting subsequent to rewriting of the program or at the time of power source on/off operation.

(16) The image forming apparatus described in the Structure (1), wherein the program for serving the functions of the conversion section and immediate conversion section is included in an updated program.

According to the Structure (16), the program for converting the data of old format into the format conforming to the updated program is included in the updated program. Since the updated program and conversion program are integrated into one, the user need not procure a conversion program separately or worry about conformity of the version between the updated program and conversion program.

(17) The image forming apparatus described in the Structure (1), wherein the investigation section checks whether or not the data of old format is present in the storage section, based on header information of the data and version information of a program.

(18) The image forming apparatus described in the Structure (17), wherein the investigation section checks by comparing version information in the header with version information of the program.

(19) The image forming apparatus described in the Structure (1), wherein the investigation section checks at the time of start-up after updating of a program.

(20) An image forming method using an image forming apparatus capable of updating a program of data of the apparatus, the method comprising: (a) reading image data to be processed by the program; (b) checking whether or not the image data is data of old format incompatible with a current program after updating the program; (c) converting the data of old format into a format conforming to the current program, when the check result shows that the image data is the data of old format; and (d) forming an image using the converted image data.

### BRIEF DESCRIPTION OF THE DRAWINGS

FIG. 1 is a block diagram representing the configuration of an image forming apparatus as an embodiment of the present invention;

FIG. 2 is a flowchart representing the system initialization to be performed by the image forming apparatus as an embodiment of the present invention after the main power source has been turned on;

FIG. 3 is a flowchart representing the processing to be performed when the sub-power source has turned on or the document manager initialization has terminated;

FIG. 4 is an explanatory diagram showing an example of the administrator setting display given on the display and operation section of the image forming apparatus as an embodiment of the present invention;

FIG. 5 is an explanatory diagram showing an example of the administrator setting display shown when there is no data of old format in the image storage section;

FIG. 6 is an explanatory diagram showing another example of the administrator setting display shown when there is no data of old format in the image storage section;

FIG. 7 is a flowchart representing the processing when the administrator setting display is shown;

FIG. 8 is a flowchart representing the processing of converting the data of old format into the format conforming to the current program;

FIG. 9 is an explanatory diagram schematically showing the transition of data in the processing of conversion;

FIG. 10 is an explanatory diagram representing an example of the conversion screen displayed on the display and operation section of the image forming apparatus as an embodiment of the present invention;

FIG. 11 is a flowchart representing processing when a job has been inputted;

FIG. 12 is an explanatory diagram representing an example of the job setting screen displaying the message for indicating that inputting of a job has been disabled; and

FIG. 13 is a flowchart showing the operation for enabling execution of the job even if it uses data of old format.

### DETAILED DESCRIPTION OF THE PREFERRED EMBODIMENT

Referring to diagrams, the following describes the preferred embodiments of the present invention.

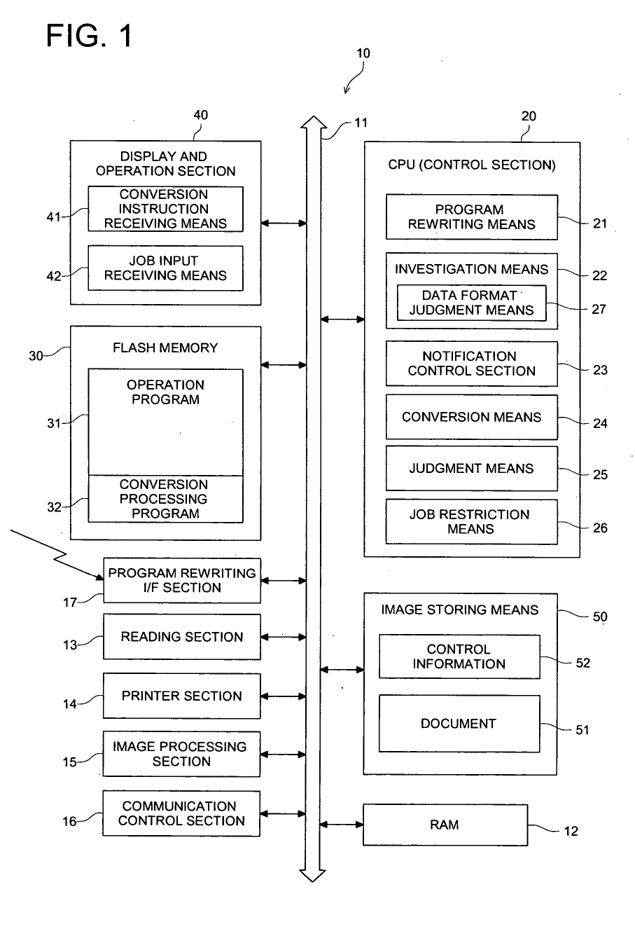

FIG. 1 shows the configuration of an image forming apparatus as an embodiment of the present invention. The image forming apparatus 10 has a scanning function of scanning a document image, a copying function of scanning the document image and forming it on a copied image on a recording sheet, a printer function of forming the image compatible with the printed data on the recording sheet, and a transfer function of transferring image data. It is commonly called a digital multifunctional machine.

The image forming apparatus 10 changes the image data obtained by scanning a document in an image file and stores it. It also rewrites an operation program in the field subsequent to shipment of a product. When the image file of old format is stored after the program has been updated, the image forming apparatus 10 converts it into the format conforming to the updated program to ensure its use.

The image forming apparatus 10 having such functions is provided with a CPU (Central Processor Unit) 20 as a control section for administer the operations of this apparatus, and is connected with various devices and apparatuses through a bus 11. Of these devices, a flash memory 30 is a nonvolatile rewritable memory for storing the programs to be run by the CPU 20, as well as various stationary data. When the program is run by the CPU 20, a RAM 12 is used as a work memory for storing various types of data temporarily, or as a page memory for storing at least the one-page image data for image rotation.

A reading section 13 reads the document image and captures the image data image data conforming thereto. The reading section 13 comprises a light source for applying light to a document; a line image sensor for reading one line across the document; a moving section for moving the line-by-line reading position along the length; and an optical path having a lens and mirror for leading the light reflected from the document, to the line image sensor. The line image sensor is composed of a CCD (Charge Coupled Device). The analog image signal outputted from the line image sensor is subjected to analog-to-digital conversion and is captured as digital image data.

A printer section 14 allows the image conforming to image data to be formed on a recording sheet according to the electrophotographic process, and permits it to be outputted. The printer section 14 is configured as a so-called laser printer comprising a recording sheet conveyance apparatus, a photoconductor drum, a charging device, a laser unit, a developing device, a transfer and separation device, a cleaning device and a fixing device.

An image processing section 15 compresses and expands the image data, enlarges and reduces the image size, and rotates the image.

A display and operation section 40 is composed of a liquid crystal display equipped with a touch panel on the surface, and various operation switches. It shows various types of message and status information for the user, and receives various operations from the user. The communication control section 16 is linked with the network such as an LAN (Local Area Network) to provide communication.

An image storage section 50 is a large capacity and nonvolatile storage section for storing a document such as an image file accommodating the image data. In the present embodiment, a hard disk device is used (HDD) as the image storage section 50. The image storage section 50 registers documents 51 and management information 52 for managing them. The management information 52 searches the document 51 stored in the image storage section 50, in the step of initialization after power source has been turned on, and is configured based on this result. It should be noted that the document is not restricted to the image data alone; it refers to various files created by the user in the data held by the system.

The program rewriting I/F section 17 is an interface for inputting the program stored in the flash memory 30 from an external device when this program is updated. For example, it can be connected with a device compatible with the USB (Universal Serial Bus), and is capable of reading the program loaded in the USB flash memory. Further, the program rewriting I/F section 17 can be the interface that reads the program via the network such as LAN.

In addition to the function of administering the operations of the image forming apparatus 10, the CPU 20 has a function of rewriting the program loaded in the flash memory 30, and various functions of allowing the data of old format (document 51) to be used on the updated program when such data of old format remains in the image storage section 50. The data of old format refers to the data of the format that cannot be processed by the program loaded in the current apparatus, but can be processed by the old version of this program.

To put it in greater details, the CPU 20 services of the functions of the program rewriting means 21, investigation means 22, notification control section 23, conversion means 24, judging means 25 and job restriction means 26. The program rewriting means 21 serves the function of rewriting the program stored in the flash memory 30, using the program captured from the program rewriting I/F section 17. Rewriting is performed after using a checksum or the like to verify that there is no problem with the program.

The investigation means 22 checks if the data of old format incompatible with the current program (document 51) is present or not in the image storage section 50. The investigation means 22 performs the function of the data format judgment means 27 that determines if each document 51 is of old format or not.

When the investigation means 22 has shown that the data of old format is present, the notification control section 23 notifies the user of this fact. To put it more specifically, this notification is given by displaying a predetermined message on the display and operation section 40.

The conversion means 24 serves the function of converting the data of old format into the format conforming to the current program. The judging means 25 determines if the job inputted by the user uses the data of old format or not. A job, a unit for requesting the image forming apparatus 10 to do tasks, which includes a copy job of copying a documents a printing job of printing according to the print data, a storage job of storing the image data obtained by reading the document, into an archive as a document, and a job of printing out or transferring the document stored in the archive. The job restriction means 26 disables inputting of the job using the data of old format stored in the image storage section 50.

In addition to the function of the conversion instruction receiving means 41 for receiving from the user the conversion execution instruction for converting the data of old format (document 51) into the format conforming to the current program, the display and operation section 40 performs the function of the job input receiving means 42 for receiving the job input operation from the user.

The conversion processing program 32 required to convert the data of old format converted into the format conforming to the updated program is provided as part of the updated program together with the operation program 31. Thus, when the program has been updated, the conversion processing program 32 serving the functions of the conversion means 24 and data format judgment means 27 is also provided and updated.

The following describes the operations of the image forming apparatus 10 after the program has been rewritten.

After the program has been rewritten correctly, the power source of the image forming apparatus 10 is turned on and the updated program is started.

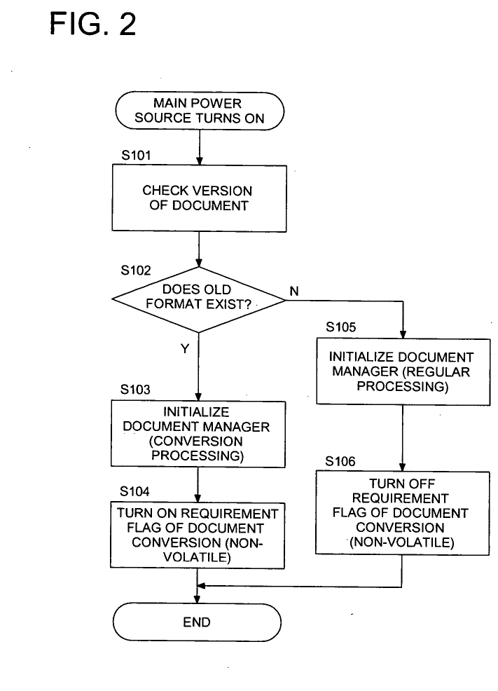

FIG. 2 shows the flow of the system initialization to be performed when the main power source has been turned on. After various parts of the apparatus have been initialized, the investigation means 22 checks if the document 51 of old format remains in the image storage section 50 or not (Step S101). Whether the format is old or not is determined by comparing the file version information contained in the header information of the document 51, with the version information of the updated program.

If the document 51 of old format is present in the image storage section 50 (Y in Step S102), document manager initialization for conversion is carried out (Step S103), and the document conversion requirement flag stored in a memory such as the flash memory 30 is turned on (is set) (Step S104) to terminate this processing (END). It should be added that the document manager is a control section for-managing the interface when the system accesses the document file. The document such as an image file is accessed through the document manager. Further, the document conversion requirement flag indicates that the document 51 of old format is present in the image storage section 50 and its conversion is necessary.

If there is no document 51 of old format in the image storage section 50 (N in Step S102), document manager initialization for normal processing is carried out (Step S105), and the document conversion requirement flag is turned off (reset) (Step S106) to terminate this processing (END).

The aforementioned processing is carried out in the power save mode, and the display and operation section 40 and others are not displayed.

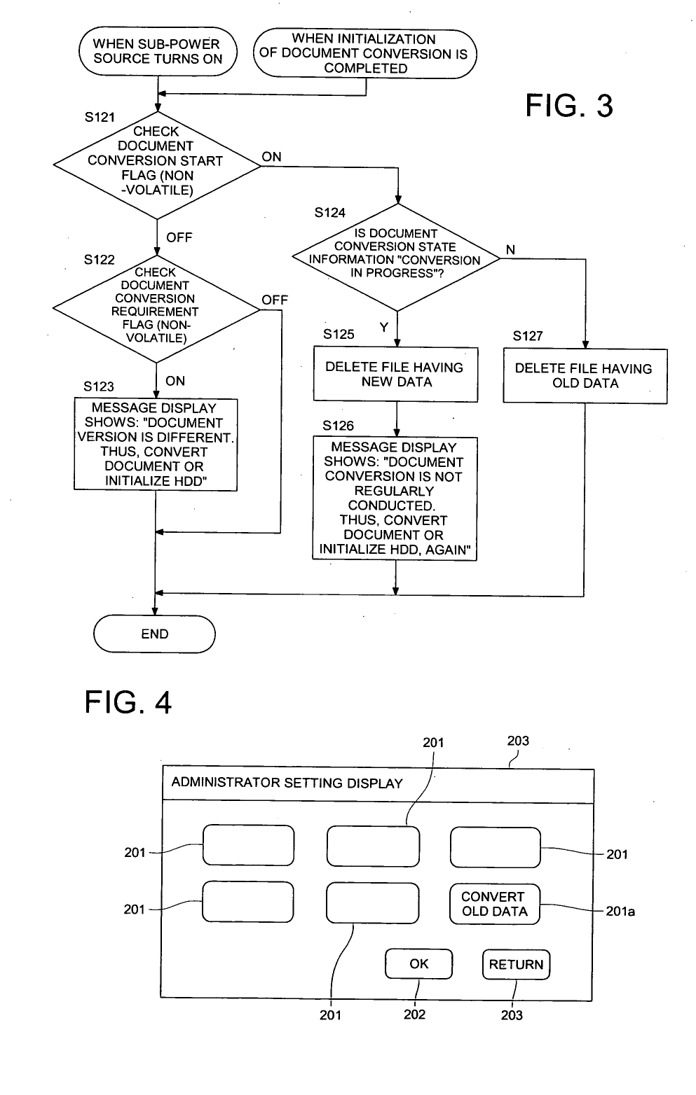

FIG. 3 shows the flow of processing to be performed when the sub-power source has turned on or the document manager initialization has terminated. If the sub-power source has turned on, the display and operation section 40 is displayed and is then placed in the state of receiving a user operation.

When the document conversion start flag to be described later is off (OFF in Step S121) and the document conversion requirement flag is on (ON in Step S122), the user is notified of the fact that the data of old format (document 51) is present in the image storage section 50 (Step S123).

For example, the message “DOCUMENT VERSION IS DIFFERENT. CONVERT DOCUMENT OR INITIALIZE HDD” appears on the display and operation section 40.

After that, normal operations are enabled. However, inputting of the job using the data of old format is disabled, as will be described later. Even when the user has been notified of the presence of the data of old format, the user wishing to execute the job that does not use the data of old format is allowed to execute the intended job so that conversion will be processed later.

The process in FIG. 3 when the document conversion start flag is on (ON in Step S121) will be described later. The following will firstly describe the operations when the data of old format is converted into the format conforming to the current program.

The execution instruction (conversion instruction) for conversion of the data of old format into the format conforming to the current program is received on the administrator setting display which only the person authorized by a password or the like is allowed to enter.

FIG. 4 shows an example of the administrator setting display. The selector buttons 201 of various functions that only the administrator is allowed to operate are shown on the administrator setting display 200. One of them is an “old data conversion” button 201a. If the ”OK” button 202 on the bottom portion of the screen is operated after selecting and operating any one of the selector buttons 201, then the selected function will be performed. If the “return” button 203 is operated, the administrator setting display 200 will terminate to get back to the previous screen.

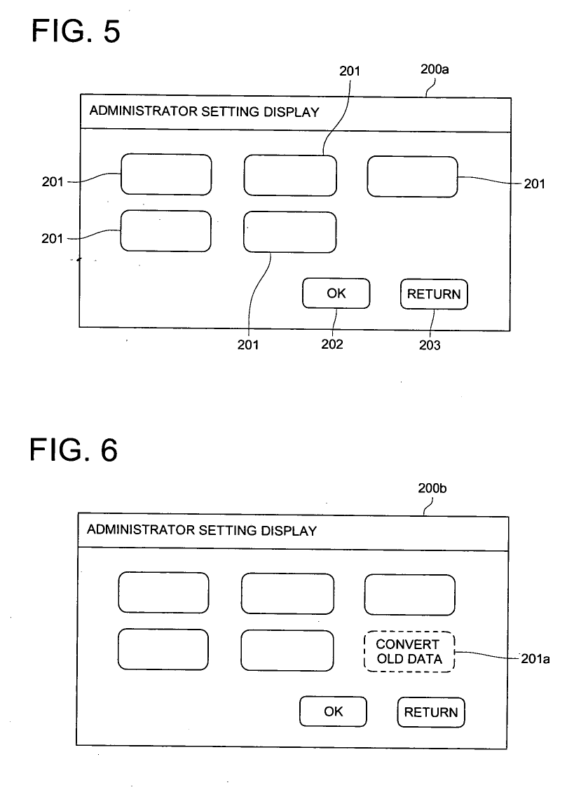

The “old data conversion” button 201a is displayed only when the data of old format (document 51) is present in the image storage section 50. If it is not present in the image storage section 50, it is not displayed on the administrator setting display 200a, as shown in FIG. 5. FIG. 6 shows an example of the administrator setting display 200b that displays the “old data conversion” button 201a in the non-active state when there is no data of old format in the image storage section 50. The non-active button is displayed dimly, but is disabled.

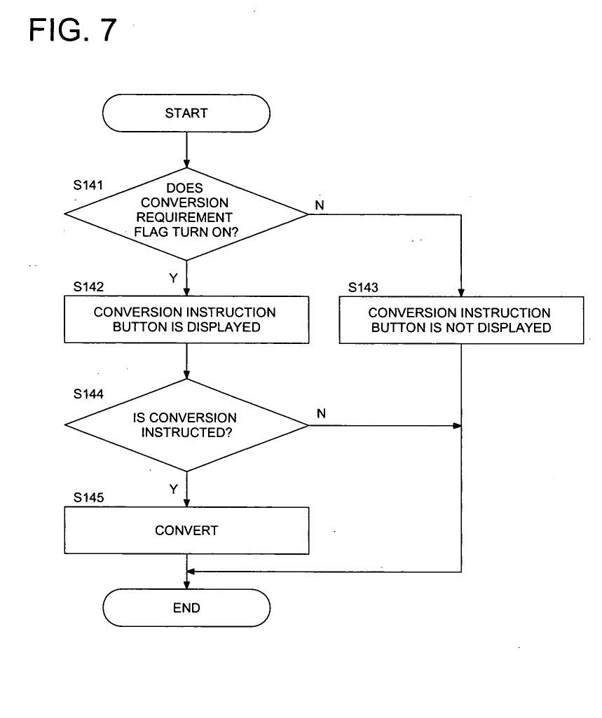

FIG. 7 illustrates the flow of the processing of showing the administrator setting display 200. When shifting to the administrator setting display 200 from another screen, a check is made to see if the document conversion requirement flag is turned on or not (Step S141). If the document conversion requirement flag is on (Y in Step S141), the administrator setting display 200 showing the “old data conversion” button 201a will appear on the display and operation section 40, as shown in FIG. 4 (Step S142). If the document conversion requirement flag is off (N in Step S141), the administrator setting display 200a where the “old data conversion” button 201a (FIG. 5) is not displayed, or the administrator setting display 200b (FIG. 6) showing the “old data conversion” button 201a in the non-active mode will appear (Step S143). In this case, this processing terminates without conversion being executed (END) the “old data conversion” button 201a is provided as a conversion instruction receiving section.

When the “old data conversion” button 201a has been operated on the administrator setting display 200 (Y in Step S144), the processing of converting the data of old format into the format conforming to the current program is carried If the “old data conversion” button 201a is not operated on the administrator setting display 200 (N in Step S144), this processing terminates without conversion being executed (END).

It is also possible to arrange such a configuration that, when the document conversion requirement flag is off, the administrator setting display 200 where the “old data conversion” button 201a is shown appears, in such a way that the operation thereof will not be accepted.

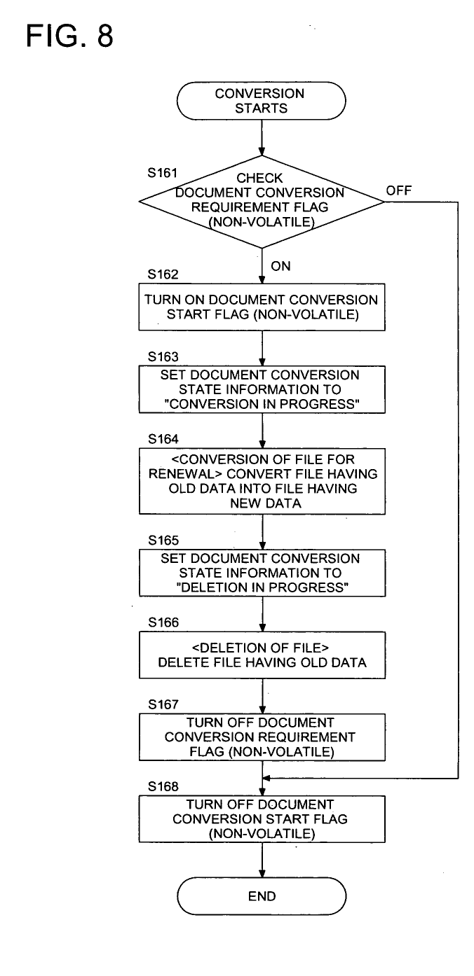

FIG. 8 shows the flow of conversion and schematically indicates the transition of data in the process of conversion. In the first place, a check is made to see if the document conversion requirement flag is on or not (Step S161). If it is off (OFF in Step S161), the data of old format to be converted (document 51) is not present in the image storage section 50, so the document conversion start flag to be described later is turned off (Step S168) to terminate the present processing (END). This status occurs, for example, when the “old data conversion” button 201a is shown on the administrator setting display 200, independently of whether the document conversion requirement flag is on or off.

If the document conversion requirement flag is on (ON in Step S161), the document conversion start flag is turned on (Step S162). The document conversion start flag indicates that the conversion has started, and is stored in the nonvolatile memory such as a flash memory 30.

Further, the document conversion state information is set to “CONVERSION IN PROGRESS” (Step S163). Conversion consists of conversion proper and post-processing. The document conversion state information indicates if the processing is halfway through the conversion proper or has shifted to the state of post-processing after termination of conversion proper. Document conversion state information is loaded in the nonvolatile memory. When the document conversion state information is “CONVERSION IN PROGRESS”, the conversion proper is halfway through processing. If it is “DELETION IN PROGRESS”, processing has shifted to the state of post-processing after termination of conversion proper.

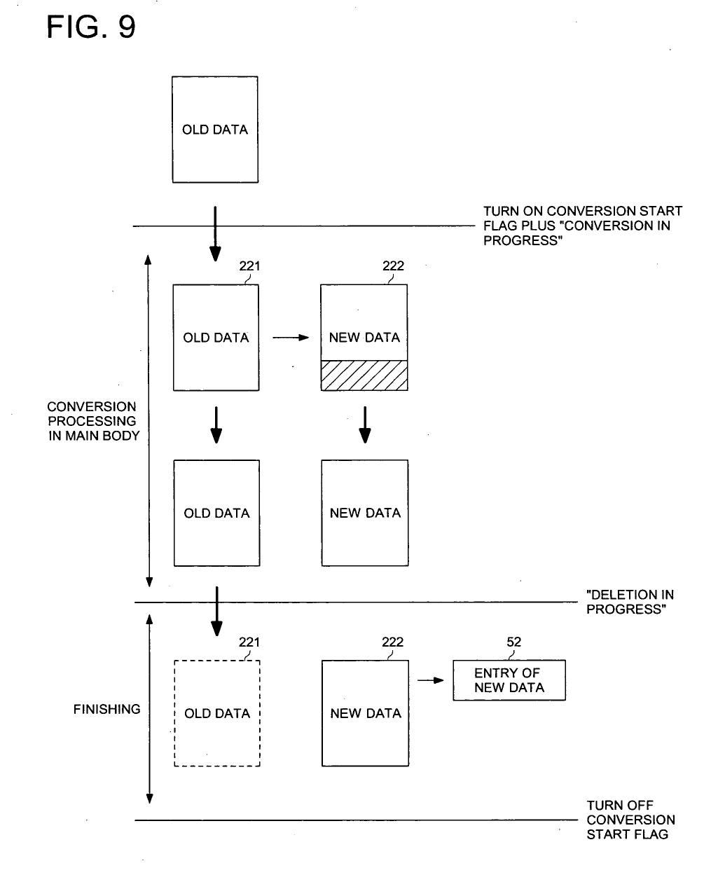

The document conversion start flag is turned on and the document conversion state information is set to the “CONVERSION IN PROGRESS”. After that, the conversion proper will be executed (Step S164). In conversion proper, the documents converted into the format conforming to the current program (new data 222) are created one after another, based on the document of old format (old data 221), as shown in FIG. 9. In this case, new data 222 is crated with the old data 221 kept unchanged.

When new data 222 corresponding to the old data 221 has been created and the conversion proper has terminated, the document conversion state information is set to “DELETION IN PROGRESS” (Step S165). After that, post-processing is performed (Step S166). Here the old data 221 is deleted in the step of post-processing. Creation of management information 52 based on the new data 222 can be included in the post-processing.

Upon completion of post-processing, the document conversion requirement flag is turned off (Step S167). Further, the document conversion start flag is turned off (Step S168) to terminate the present processing (END).

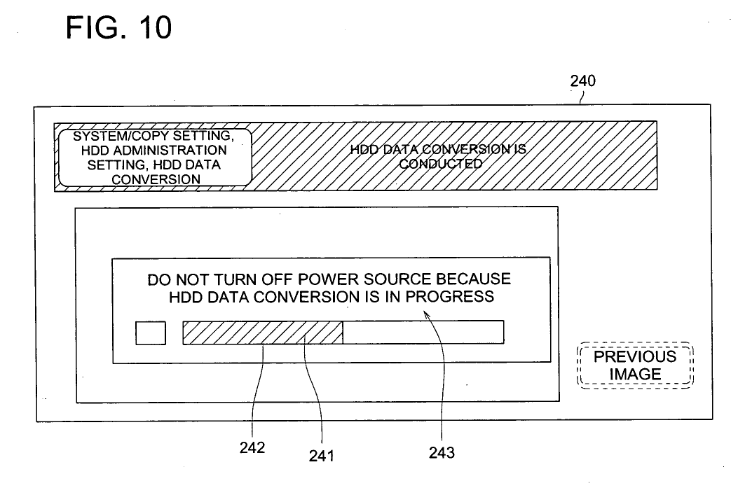

FIG. 10 shows an example of the screen displayed on the display and operation section 40 CONVERSION IN PROGRESS. The Conversion-in-Progress screen 240 shows a progress display section 242 showing the progress of conversion expressed by the length of a level bar 241, and an warning message 243 for warning the user not to turn off the power source since the system is currently in the process of conversion.

The progress of conversion is expressed by the statuses of the document conversion start flag and document conversion state information. To be more specific, as shown in FIG. 9, when the document conversion start flag is on and the document conversion state information is “CONVERSION IN PROGRESS”, it can be seen that the conversion proper is currently in progress. Further, if the document conversion start flag is on and the document conversion state information is “DELETION IN PROGRESS”, it can be seen that post-processing is not yet terminated although conversion proper has terminated. If the document conversion start flag is off, it can be seen that conversion is not yet started or the post-processing is not yet terminated.

The document conversion start flag and document conversion state information are loaded in the nonvolatile memory. If the power source of the image forming apparatus 10 has been turned off halfway through conversion, it is possible to see if the power source has been turned off halfway through conversion or not, by checking the document conversion start flag and document conversion state information after power source has been turned on.

In the processing shown in FIG. 3, the document conversion start flag and document conversion state information are checked, and required recovery procedures are taken. To be more specific, the document conversion start flag is checked in the processing shown in FIG. 3. If the result of this check indicates that the flag is on (ON in Step S121), then a check is made to see if the document conversion state information is “CONVERSION IN PROGRESS” or not. If the result indicates that this information is “CONVERSION IN PROGRESS” (Y in Step S124), it can be seen that the power source is disconnected during conversion proper. Thus, the new data 222 created halfway is deleted (Step S125), and the user is notified of the fact that the correct conversion has failed (Step S126). Then the present processing terminates (END). When a conversion instruction is inputted from-the administrator setting display 200 at appropriate times thereafter, conversion shown in FIG. 8 will be started from the beginning.

If the document conversion state information is “DELETION IN PROGRESS” (N in Step S124), it can bee seen that power source has been turned off when post-processing has not yet terminated although conversion proper has terminated. Thus, the post-processing (deletion of the old data 221) is carried out. In practice, Steps S166 through S168 are performed and the relevant flag is turned off.

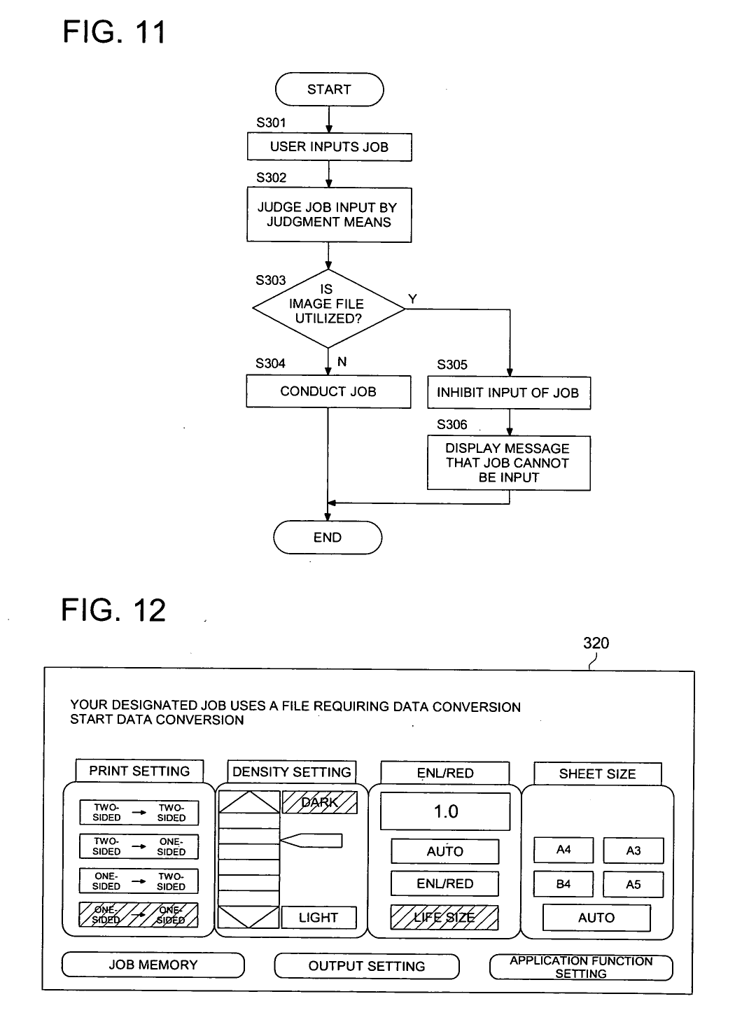

Referring to FIG. 11, the following describes the operation when the job is inputted without converting the data of old format.

The user selects the type of the job, such as copying and image file transfer, and the various types of parameters (resolution and density of scanning, destination of image file transmission, etc.) related to the job are set as required. Then the job is inputted by operating the start button (not illustrated).

When the job has been inputted (Step S301), the judging means 25 checks if the job uses the data of old format or not (Step S302). For example, if the inputted job is the one for accessing the document file stored in the image storage section 50 and the document conversion requirement flag is set (data of old format present), then the job is regarded as using the data of old format.

The job for accessing the document file stored in the image storage section 50 includes the one of sending the document 51 stored in the archive, to an external device, and the one of printing out the same. The job that does not use the data of old format includes the copying job, and the job of scanning the document and storing its image data in the archive as a document.

Whether the inputting of a job is disabled or not can be determined in units of the document used in the job, in addition to the type of the job. For example, it is possible to arrange the following configuration. When the presence of data of old format has been detected in the step of initialization, management information 52 associated with the data of old format is created. This management information 52 is referenced to determine whether the document designated the user this time contains the data of old format or not.

If the job has been determined as the one that does not use the data of old format (N in Step S303), this job is executed as a regular job (Step S304). If the inputted job uses the data of old format (Y in Step S303), then inputting of that job is disabled (Step S305) and a message is displayed for the user to indicate that the job cannot be inputted (Step S306).

FIG. 12 shows an example of the job setting screen 320 displaying the message for indicating that inputting of a job has been disabled. The job setting screen 320 shows the message that reads “YOUR DESIGNATED JOB USES A FILE REQUIRING DATA CONVERSION. START DATA CONVERSION.” In this way, the user is notified of the reason for disabled inputting of the job, whenever necessary. This arrangement is convenient for the user not having viewed the message, indicating the presence of data of old format, displayed when the power source was turned on. The message also tells the user that the data can be used if the format is converted. This will allow the user to take proper action.

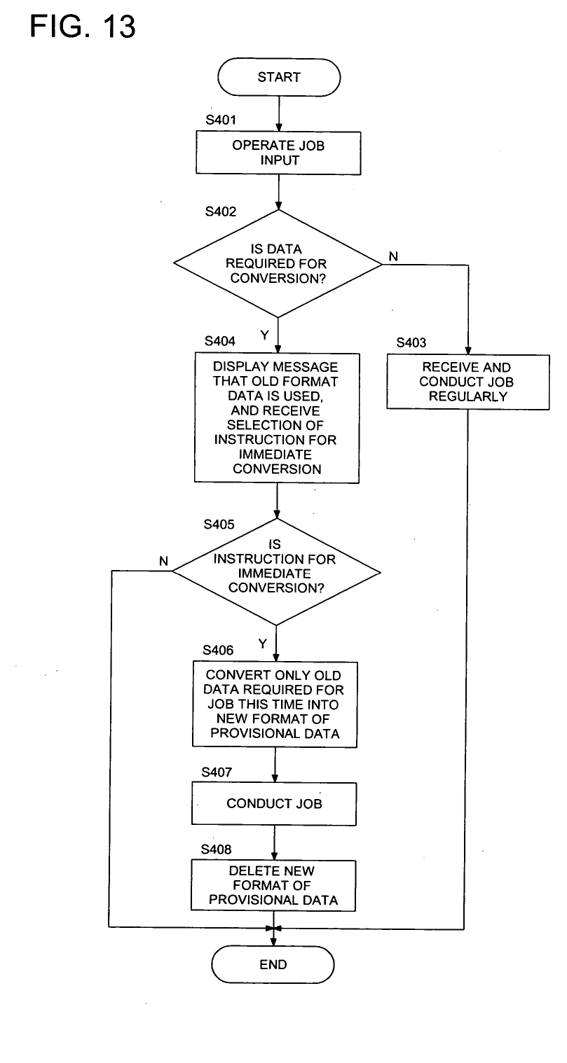

FIG. 13 shows the operation for enabling execution of the job even if it uses data of old format. If a job has been inputted by the user (Step S401), a check is made to determine if the job uses the data of old format or not (Step S402). If the job does not use the data of old format (N in Step S402), the job is executed as a regular job (Step S403).

When the job uses the data of old format (Y in Step S402), the user is notified of the fact that the job uses the data of old format, and is asked whether only the data of old format used this time should be converted into the format conforming to the current program and should be executed forcibly (Step S404).

When an instruction has been received from the user to convert the data of old format to be used this time, into the format conforming to the current program (Y in Step S405), only the data of old format to be used this time is converted into the format conforming to the current program (Step S406), and the converted data is used to execute the job (Step S407). Upon completion of the job execution, the converted data used in this job will be deleted (Step S408).

When an instruction has been received from the user not to convert the data of old format to be used this time (N in Step S405), execution of the job this time will be rejected and the processing will terminate (END).

It is also possible to make such arrangements that the converted data used in this job is not deleted subsequent to execution of the job. In this case, when the job using the same data has been inputted again, the job can be executed without the need of further conversion, with the result that the user' wait time can be reduced.

The embodiment of the present invention has been described with reference to diagrams. It is to be expressly understood, however, that the present invention is not restricted thereto. The present invention can be embodied in a great number of variations with appropriate modification or additions, without departing from the technological spirit and scope of the invention claimed. For example, in the aforementioned embodiment, whether or not the data of old format is present in the image storage section 50 is checked in the step of initialization when power source is on. It is also possible to arrange such a configuration that this check is made at other times, for example, in response to the user's operation.

In the aforementioned embodiment, if there is data of old format, the user is notified of this fact, and conversion is carried out after the conversion instruction is received from the user through the administrator setting display. It is also possible to arrange such a configuration that the data of old format is automatically converted upon detection of its presence.

In the aforementioned embodiment, if the conversion program for converting the data of old format into the format conforming to the current program is included in the updated program. It is also possible to arrange such a configuration that the conversion program is installed separately.

Further, in the aforementioned embodiment, the digital multifunctional machine is used as an example for explanation. The program can be updated in the field after shipment, and the present invention applies to various types of apparatuses (image forming apparatuses) where the data of old format may be stored in the nonvolatile storage device.

The image forming apparatus of the embodiment invention converts the data of old format incompatible with an updated program, into the format conforming to the updated program. Thus, even after the program has been rewritten, the data before rewriting can be used, with the result that there is no need of initializing or deleting the information stored in the storage section, every time the program is updated. This ensures the program to be rewritten without the important data being lost.

In an apparatus wherein, when the data of old format incompatible with the current program remains in the storage section, the user is notified of this fact, the user can choose to start conversion of the data of old format at convenient times if the conversion takes a long time.

In an apparatus wherein, based on the conversion instruction given by the user, the data of old format can be converted into the format conforming to the current program, conversion can be performed at any time desired by the user. Especially in the type of the apparatus wherein the conversion instruction receiving button is not displayed when the data of old format is not present in the storage section, the maneuverability is improved since irrelevant operation keys are not shown.

In an apparatus wherein, when the data of old format is present in the storage section, restrictions are placed on the execution of the job of using the data of old format, but execution of other jobs is enabled, a user desiring to execute the job that does not use the data of old format is allowed to execute the intended job immediately in such a way that conversion will be processed later, if the conversion that may take a long time.

In an apparatus wherein, when the job inputted by the user uses the data of old format, only the data of old format included therein is converted into the format conforming to the current program, and the job is executed thereafter, only the data used in the current job is converted. This arrangement reduces the conversion time and allows the data of old format to be used immediately, without the need of forcing the user to wait for a long time.

In an apparatus wherein the data converted for execution of the job is deleted subsequent to execution of the job, the arrangement thereof prevents the data converted into the format conforming to the current program, from remaining in the storage section without permission of the administrator.

In an apparatus wherein conversion consists of conversion proper and post-processing, and, if power source is disconnected during conversion proper, conversion is restarted from the beginning after the power source has been recovered, whereas, if the power source has been disconnected during execution of post-processing, operation is restarted from the post-processing after the power source has been recovered, only the required processing is restarted after the power source has been turned on. This arrangement reduces the time of processing up to the termination of conversion.

In an apparatus wherein the data to be processed by the program is image data, the image asset stored in the storage section can be used even after program has been updated.

In an apparatus wherein, immediately after the program has been rewritten, investigation is made to see whether or not data of old format is present in the storage apparatus, the user is notified of the presence of the data of old format immediately after the program has been updated. This arrangement allows the user to take action earlier.

In an apratus wherein the program for converting the data of old format is provided as part of the updated program, the updated program and conversion program are integrated into one. Thus, the user need not procure a conversion program separately or worry about conformity of the version between the updated program and conversion program, with the result that convenience for the user is greatly enhanced

1. An image forming apparatus capable of updating a program of data thereof, comprising:
(a) a storage section for storing the data to be processed by the program;
(b) an investigation section for checking whether or not data of old format incompatible with a current program is present in the storage section;
(c) a conversion section for converting the data of old format in the storage section, into a format conforming to the current program, when the investigation section shows that the data of old format is present; and
(d) an image forming section for forming an image using the converted data.

2. The image forming apparatus of claim 1, further comprising a notification control section for notifying a check result of the investigation section when the investigation section shows that the data of old format is present.

3. The image forming apparatus of claim 2, further comprising a conversion instruction receiving section for receiving an instruction for converting the data,
wherein the conversion section converts the data of old format to the format conforming to the current program, based on the conversion instruction received by the conversion instruction section.

4. The image forming apparatus of claim 3, wherein the conversion instruction receiving section is not displayed when the investigation section has indicated that there is no data of old format.

5. The image forming apparatus of claim 2, wherein when the investigation section shows that the data of old format is present, a status of the apparatus is shifted to one where execution of a job using the data of old format existed in the storage section, is restricted but execution of other jobs is permitted.

6. The image forming apparatus of claim 2, further comprising:
a job input receiving section for receiving a job inputted by a user;
a judgment section for judging whether or not the job utilizes data of old format incompatible with the current program when the job has been inputted by the user; and
a job restriction section for prohibiting the job to be inputted when the judgment section indicates that the data of old format is used.

7. The image forming apparatus of claim 2, further comprising:
a job input receiving section for receiving a job inputted by a user;
a judgment section for judging whether or not the job utilizes data of old format incompatible with the current program when the job has been inputted by the user; and
an immediate conversion section for converting the data of old format used in the job, into a format conforming to the current program, when the judgment section indicates that the data of old format is used, wherein the image forming apparatus executes the job using the data converted by the immediate conversion section.

8. The image forming apparatus of claim 7, wherein the data of old format is left and the data converted by the immediate conversion section is deleted after the execution of the job using the data converted is completed.

9. The image forming apparatus of claim 1, wherein when a power source has been disconnected during a conversion of the data of old format into the format conforming to the current program, the conversion is restarted from the beginning after the power source is recovered, and when the power source has been disconnected during a predetermined post-processing to be performed after the conversion is completed, the predetermined post-processing is restarted from the beginning after the power source is recovered.

10. The image forming apparatus of claim 1, further comprising:
a job input receiving section for receiving a job inputted;
a judgment section for judging whether or not the job utilizes data of old format incompatible with the current program when the job has been inputted; and
a job restriction section for prohibiting the job to be inputted when the judgment section indicates that the data of old format is used.

11. The image forming apparatus of claim 1, further comprising:
a job input receiving section for receiving a job inputted;
a judgment section for judging whether or not the job utilizes data of old format incompatible with the current program when the job has been inputted; and
an immediate conversion section for converting the data of old format used in the job, into a format conforming to the current program, when the judgment section indicates that the data of old format is used,
wherein the image forming apparatus executes the job using the data converted by the immediate conversion section.

12. The image forming apparatus of claim 11, wherein the data of old format is left unchanged and the data converted by the immediate conversion section is deleted after the execution of the job using the data is completed.

13. The image forming apparatus of claim 1, wherein the data to be processed by the program is image data.

14. The image forming apparatus of claim 1, wherein the investigation section operates when the program is rewritten.

15. The image forming apparatus of claim 1, wherein the investigation section operates at the time of start-up and initialization of the image forming apparatus.

16. The image forming apparatus of claim 1, wherein the program for serving the functions of the conversion section and immediate conversion section is included in an updated program.

17. The image forming apparatus of claim 1, wherein the investigation section checks whether or not the data of old format is present in the storage section, based on header information of the data and version information of a program.

18. The image forming apparatus of claim 17, wherein the investigation section checks by comparing version information in the header with version information of the program.

19. The image forming apparatus of claim 1, wherein the investigation section checks at the time of start-up after updating of a program.

20. An image forming method using an image forming apparatus capable of updating a program of data of the apparatus, the method comprising:
(a) reading image data to be processed by the program;
(b) checking whether or not the image data is data of old format incompatible with a current program after updating the program;
(c) converting the data of old format into a format conforming to the current program, when the check result shows that the image data is the data of old format; and
(d) forming an image using the converted image data.
